(19) United States
(12) Patent Application Publication
(10) Pub. No.: US 2026/0151962 A1
(43) Pub. Date: Jun. 4, 2026

(54) THREE-DIMENSIONAL MOLDING DEVICE

(71) Applicant: SEIKO EPSON CORPORATION, Tokyo (JP)

(72) Inventor: Eiji OKAMOTO, MATSUMOTO-SHI (JP)

(21) Appl. No.: 19/401,587

(22) Filed: Nov. 26, 2025

(30) Foreign Application Priority Data
Nov. 29, 2024 (JP) 2024-208271

(51) Int. Cl. B29C 64/336; B29C 64/106; B29C 64/209; B29C 64/314; B29K 101/12; B29K 105/06; B33Y 30/00

(52) U.S. Cl. CPC B29C 64/336; B29C 64/106; B29C 64/209; B29C 64/314; B33Y 30/00; B29K 2101/12; B29K 2105/06

(57) ABSTRACT

A three-dimensional molding device includes a plasticizing section; a fiber material supply section; a first communication path through which the molten material passes; a second communication path through which the fiber material passes; a flow path configured to allow path of the molten material that has passed through the first communication path and the fiber material that has passed through the second communication path; a material switching section that controls communication among the first communication path, the second communication path, and the flow path; a nozzle; and a control section, wherein the material switching section includes a slide section that moves in a direction intersecting an axial direction of the flow path, and the control section controls the material switching section to perform switching between a first mode in which the first communication path and the flow path communicate with each other and the second communication path and the flow path do not communicate with each other, a second mode in which the first communication path and the flow path do not communicate with each other and the second communication path and the flow path communicate with each other, a third mode in which the first communication path and the second communication path communicate with the flow path, and a fourth mode in which neither the first communication path nor the second communication path communicates with the flow path.

The present application is based on, and claims priority from JP Application Serial Number 2024-208271, filed Nov. 29, 2024, the disclosure of which is hereby incorporated by reference herein in its entirety.

### BACKGROUND

### 1. Technical Field

The present disclosure relates to a three-dimensional molding device.

### 2. Related Art

The disclosure in JP-A-2022-131037 discloses a three-dimensional molding device that introduces a second fiber material, which is longer than the first fiber material, into a molten material containing the first fiber material and a thermoplastic resin, and forms a three-dimensional molded object containing both the first fiber material and second fiber material.

In the three-dimensional molding device, switching between ejection of the molten material and ejection of the fiber material from the nozzle has not been considered.

### SUMMARY

According to a first aspect of the present disclosure, a three-dimensional molding device is provided. The three-dimensional molding device includes a plasticizing section that plasticizes at least a portion of material containing thermoplastic resin to generate molten material; a fiber material supply section that supplies fiber material; a first communication path that communicates with the plasticizing section and through which the molten material passes; a second communication path that communicates with the fiber material supply section and through which the fiber material passes; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage, wherein the material switching section includes a slide section that moves in a direction intersecting an axial direction of the flow path and the control section controls the material switching section to switch among a first mode in which the first communication path is in communication with the flow path and the second communication path is not in communication with the flow path, a second mode in which the second communication path is in communication with the flow path and the first communication path is not in communication with the flow path, a third mode in which both the first communication path and the second communication path are in communication with the flow path, and a fourth mode in which neither the first communication path nor the second communication path is in communication with the flow path.

### BRIEF DESCRIPTION OF THE DRAWINGS

FIG. 1 is an explanatory diagram illustrating a schematic configuration of a three-dimensional molding device according to a first embodiment.

FIG. 2 is an explanatory diagram illustrating a schematic configuration of a molding section.

FIG. 3 is a perspective view showing a schematic configuration of a flat screw.

FIG. 4 is a schematic plan view of a barrel.

FIG. 5 is a diagram illustrating a position of a slide section in a first mode.

FIG. 6 is a diagram illustrating a position of a slide section in a second mode.

FIG. 7 is a diagram illustrating a position of a slide section in a third mode.

FIG. 8 is a diagram illustrating a position of a slide section in a fourth mode.

FIG. 9 is an explanatory diagram illustrating an example of a schematic configuration of a molding section according to another embodiment.

### DESCRIPTION OF EMBODIMENTS

### A. First Embodiment

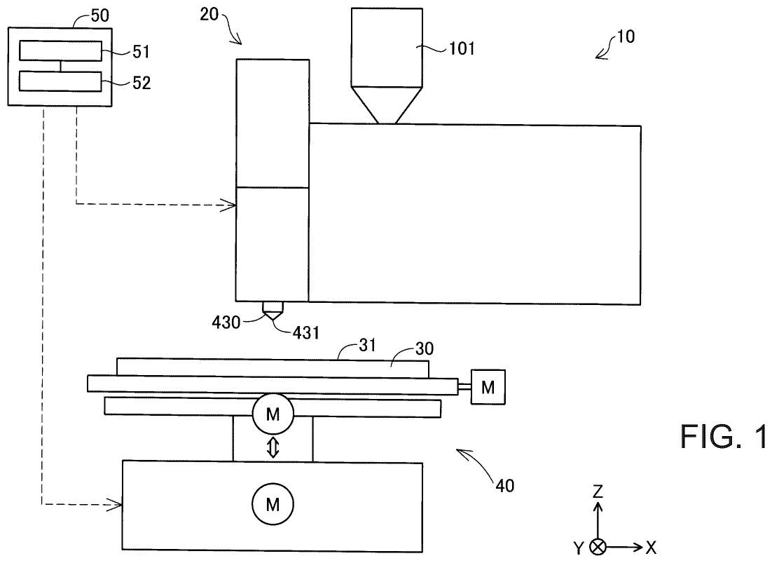

FIG. 1 is an explanatory view showing a schematic configuration of a three-dimensional molding device 10 in a first embodiment. In FIG. 1, arrows indicating X, Y, and Z directions orthogonal to each other are shown. The X direction and the Y direction are directions parallel to a horizontal plane. The Z direction is a direction parallel to the vertical direction. The X, Y, and Z directions in FIG. 1 and the X, Y, and Z directions in other drawings indicate the same directions. When a direction is specified, positive and negative signs are used together with the direction notation, wherein the positive direction, which is the direction indicated by the arrow, is “+,” and the negative direction, which is the direction opposite to the direction indicated by the arrow, is “−.” The +Z direction is also referred to as “up,” and the −Z direction is also referred to as “down.”

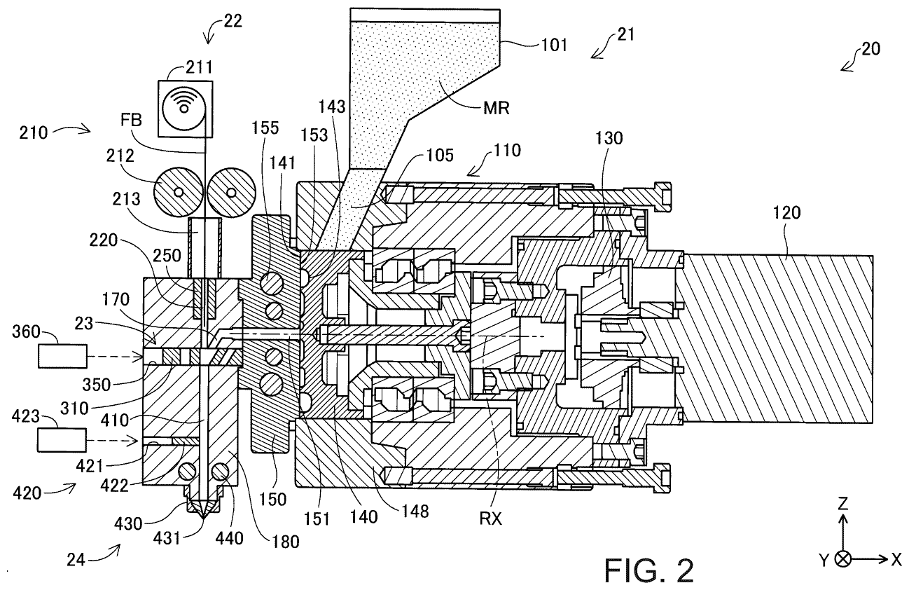

The three-dimensional molding device 10 is a device that molds a three-dimensional molded object by a material discharge method. The three-dimensional molding device 10 includes a molding section 20 that generates and ejects a molten material, a molding stage 30 serving as a base stage of a three-dimensional molded object, a movement mechanism 40 that controls a ejection position of the molten material, and a control section 50 that controls each section of the three-dimensional molding device 10. FIG. 2 is an explanatory diagram illustrating a schematic configuration of the molding section 20. Hereinafter, each section of the three-dimensional molding device 10 will be described with reference to FIGS. 1 and 2.

The molding section 20 ejects a molten material obtained by plasticizing a material in a solid state onto the stage 30 under the control of the control section 50. The molding section 20 includes a molten material introduction section 21, a fiber material introduction section 22, a material switching section 23, and a ejection section 24.

The molten material introduction section 21 generates a molten material and guides the generated molten material to the material switching section 23. The molten material introduction section 21 includes a material supply section 101, a plasticizing section 110, and a first communication path 170.

The material supply section 101 supplies the material MR to the plasticizing section 110. The material supply section 101 is configured by, for example, a hopper that accommodates the material MR. The material supply section 101 is connected to the plasticizing section 110 via a material supply path 105. The material MR is put in the material supply section 101 in the form of pellets, powder, or the like. As the material MR, for example, thermoplastic resin such as acrylonitrile butadiene styrene (ABS), polyether ether ketone (PEEK), polypropylene (PP) or the like, is used. The material MR may include inorganic material such as metal or ceramic.

The plasticizing section 110 generates a pasty molten material in which fluidity is expressed by plasticizing at least a portion of the material MR supplied from the material supply section 101. In the present embodiment, “plasticization” means a concept including melting, and means a change from a solid state to a fluid state. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point. The plasticizing section 110 includes a drive motor 120, a decelerator 130, a flat screw 140, and a barrel 150. The flat screw 140 is also referred to as a rotor, a scroll, or simply a screw. The barrel 150 is also called a screw facing section.

The flat screw 140 is housed in the screw case 148. The flat screw 140 is connected to the drive motor 120 via the decelerator 130, and rotates about the rotation axis RX in the screw case 148 by a rotational driving force generated by the drive motor 120. In the present embodiment, the direction of the rotation axis RX is along the X direction.

The rotation of the flat screw 140 by the drive motor 120 is controlled by the control section 50. The barrel 150 is arranged on the −X direction side of the flat screw 140.

The flat screw 140 may be directly coupled to the drive motor 120 without the decelerator 130.

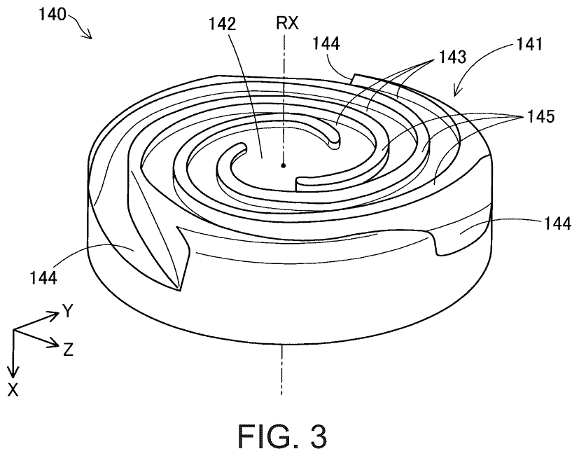

FIG. 3 is a perspective view showing a schematic configuration of the flat screw 140. The flat screw 140 has a substantially columnar shape in which the height in the direction along the central axis is smaller than the diameter. The central axis of the flat screw 140 coincides with the rotation axis RX. A spiral groove 143 is formed around a central section 142 on a groove forming surface 141 of the flat screw 140 facing the barrel 150. The groove 143 communicates with a material introduction port 144 formed on a side surface of the flat screw 140. The material MR supplied from the material supply section 101 is supplied to the groove 143 through the material introduction port 144. The grooves 143 are formed by being separated from each other by ridge sections 145. FIG. 3 shows an example in which three grooves 143 are formed, but the number of grooves 143 may be one, two, or more. The grooves 143 are not limited to a spiral shape, may be helical or involute curvilinear, and may extend so as to draw an arc from the central section 142 to the outer periphery.

As illustrated in FIG. 2, a barrel heater 155 for heating the material MR supplied into the groove 143 of the flat screw 140 is embedded in the barrel 150. The temperature of the barrel heater 155 is controlled by the control section 50.

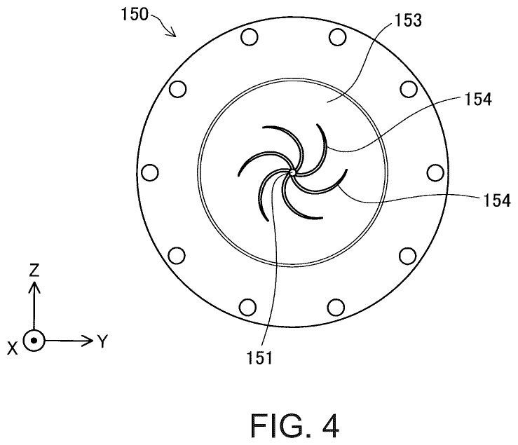

FIG. 4 is a schematic plan view of the barrel 150. The barrel 150 has a facing surface 153 that faces the groove forming surface 141 of the flat screw 140. A communication hole 151 penetrating the barrel 150 in the X direction is formed at the center of the facing surface 153. A plurality of guide grooves 154 connected to the communication hole 151 and extending in a spiral shape from the communication hole 151 toward the outer periphery are formed in the facing surface 153. The barrel 150 may not be provided with the guide groove 154.

The guide groove 154 may not be connected to the communication hole 151.

The material MR supplied to the groove 143 of the flat screw 140 flows along the groove 143 and the guide groove 154 by the rotation of the flat screw 140 while being plasticized between the flat screw 140 and the barrel 150 by the rotation of the flat screw 140 and the heating of the barrel heater 155, and is guided to the central section 142 of the flat screw 140. The molten material flowing into the central section 142 flows out from the communication hole 151 provided at the center of the barrel 150 to the first communication path 170. Note that in the molten material, all the substances constituting the molten material may not be plasticized. It is sufficient that the molten material is converted into a state having fluidity as a whole by plasticizing at least some kinds of substances among substances constituting the molten material.

The first communication path 170 is a hole formed in the block 180, which is a member arranged on the −X direction side of the barrel 150. One end of the first communication path 170 is connected to the communication hole 151, and the other end of the first communication path 170 is connected to the material switching section 23. In other words, the first communication path 170 communicates with the plasticizing section 110. The molten material generated in the plasticizing section 110 passes through the first communication path 170 and flows out to the material switching section 23. In the present embodiment, the first communication path 170 is a bent hole. The first communication path 170 has a portion extending along the X direction and, in the XZ plane, a portion extending obliquely with respect to the X direction. An end section on the +X direction side of the portion extending along the X direction is connected to the communication hole 151. The end section on the −X direction side and the −Z direction side of the portion extending obliquely with respect to the X direction in the XZ plane is connected to the material switching section 23. The first communication path 170 may be a hole extending linearly.

The fiber material introduction section 22 includes a fiber material supply section 210 and a second communication path 220. The fiber material supply section 210 supplies the fiber material FB to the material switching section 23. The fiber material supply section 210 includes an accommodation section 211, a transport roller 212, and a transport path 213. The fiber material FB wound around a reel is accommodated in the accommodation section 211. The transport rollers 212 are a pair of rollers that sandwich the fiber material FB supplied from the accommodation section 211. The transport roller 212 is provided below the accommodation section 211. The transport rollers 212 rotate about the each axes thereof in a state of sandwiching the fiber material FB, and thus the fiber material FB is transported from the accommodation section 211 toward the material switching section 23. In the present embodiment, the direction along the axis of the transport roller 212 is the Y direction. The rotation of the transport roller 212 is controlled by the control section 50. The transport path 213 is a cylindrical member provided below the transport roller 212, and the fiber material FB sent out from the accommodation section 211 passes through the inside thereof. The fiber material supply section 210 may not include the transport path 213. The method of transporting the fiber material FB is not limited to the above-described method. For example, the fiber material FB may be transported from the accommodation section 211 toward the material switching section 23 by rotating a reel around which the fiber material FB is wound by a motor.

The second communication path 220 is a hole formed in the block 180 and extending linearly. In the present embodiment, the axis of the second communication path 220 is along the Z direction. One end of the second communication path 220 is connected to the transport path 213, and the other end of the second communication path 220 is connected to the material switching section 23. In other words, the second communication path 220 communicates with the fiber material supply section 210. The fiber material FB supplied from the fiber material supply section 210 passes through the second communication path 220 and is transported to the material switching section 23. The axis of the second communication path 220 and the axis of the transport path 213 coincide with each other. In the present embodiment, the fiber material FB is transported from the accommodation section 211 to the material switching section 23 along the −Z direction so as not to be bent before reaching the material switching section 23.

The fiber material FB is formed of a fiber bundle in which a plurality of fibers is bundled. In the present embodiment, the fiber material FB has a configuration in which a plurality of carbon fibers are bundled by a bundling agent. The fiber material FB may be made of fiber material other than carbon fiber, and may be made of, for example, glass fiber. The fiber material FB may be formed of various fibers having a higher elastic modulus than the material MR. The fiber material FB may be formed of one fiber. The fiber material FB may be a fiber bundle in which a plurality of fibers is bundled or a material in which a single fiber is impregnated with a thermoplastic resin. The diameter of the fiber material FB may be, for example, 5 μm or more and equal to or less than the hole diameter of a nozzle opening 431 described later. Here, the diameter of the fiber material FB corresponds to the maximum width dimension in a cross section orthogonal to the length direction of the fiber bundle constituting the fiber material FB.

A heat insulation material 250 is provided between the second communication path 220 and the plasticizing section 110. In the present embodiment, the heat insulation material 250 is a cylindrical member and is embedded in the block 180 so as to surround the second communication path 220. The heat insulation material 250 is made of, for example, ceramic, glass fiber, polytetrafluoroethylene (PTFE), or the like. The heat insulation material 250 may be provided between the second communication path 220 and the plasticizing section 110, and may be embedded between the second communication path 220 and the barrel 150 in the block 180, or may be provided between the block 180 and the barrel 150, for example.

The material switching section 23 is connected to the first communication path 170, the second communication path 220, and a flow path 410 described later, and switches communication between the first communication path 170, the second communication path 220, and the flow path 410. The material switching section 23 includes a slide section 310 that moves in a direction intersecting the axial direction of the flow path 410. Hereinafter, the direction intersecting the axial direction of the flow path 410 is also referred to as a first direction. In the present embodiment, the first direction is the X direction. The slide section 310 is arranged inside a first hole 350 formed in the block 180. The first hole 350 is a through hole penetrating the block 180 in the X direction, which is the first direction, and communicates with the first communication path 170, the second communication path 220, and the flow path 410. The first hole 350 may not be a through hole, but may be a hole having a bottom surface provided from the surface of the block 180 on the +X direction side toward the −X direction, or may be a hole having a bottom surface provided from the surface of the block 180 on the −X direction side toward the +X direction. In the present embodiment, the slide section 310 moves in the X direction inside the first hole 350. The slide section 310 is driven by the first drive section 360 under the control of the control section 50. The first drive section 360 is configured by, for example, a stepping motor, a rack and pinion mechanism that converts a rotational force of the stepping motor into a parallel motion of the slide section 310, or the like. The control section 50 controls the position of the slide section 310 in the first direction inside the first hole 350 using the first drive section 360. The detailed structure of the slide section 310 will be described later.

The ejection section 24 includes a flow path 410, a suction section 420, a nozzle 430, and a nozzle heater 440. The flow path 410 is a hole extending linearly and formed on the −Z direction side of the material switching section 23 in the block 180. The axis of the flow path 410 extends along the Z direction. In other words, the axial direction of the flow path 410 is a direction along the axial direction of the second communication path 220. The axial direction of the flow path 410 intersects the axial direction of the first communication path 170. The flow path 410 is connected to the material switching section 23, and the molten material passing through the first communication path 170 and the fiber material FB passing through the second communication path 220 can pass through the flow path 233.

The nozzle 430 is arranged at the lower end of the block 180. The nozzle 430 communicates with the flow path 410 and ejects the molten material and the fiber material FB passing through the flow path 410 from a nozzle opening 431 at the distal end toward the stage 30.

The nozzle heater 440 is arranged around a portion of the flow path 410 located in the vicinity of the nozzle 430. The nozzle heater 440 heats the molten material in the flow path 410 in the vicinity of the nozzle 430. The temperature of the nozzle heater 440 is controlled by the control section 50.

The suction section 420 suppresses the tailing phenomenon, in which the molten material drips like a thread from the nozzle opening 431, by temporarily suctioning the molten material in the flow path 410 when the molten material ejecting from nozzle 430 is paused. The suction section 420 includes a branch path 421, a plunger 422, and a plunger drive section 423. The branch path 421 is a hole formed in the block 180 and extending linearly, and is connected to the flow path 410. In the present embodiment, the direction in which the branch path 421 extends is the X direction. The plunger 422 is a shaft-shaped member and is arranged in the branch path 421. The plunger drive section 423 generates a driving force for instantaneously reciprocating the plunger 422 in the branch path 421 under the control of the control section 50. The plunger drive section 423 is configured by, for example, an actuator such as a solenoid mechanism, a piezoelectric element, or a motor. In a case where the ejection of the molten material from the nozzle 430 is temporarily interrupted, the control section 50 controls the plunger drive section 423 to momentarily move the plunger 422 so that the distal end section of the plunger 422 moves from the connecting section between the flow path 410 and the branch path 421 to a hidden position within the branch path 421. Accordingly, a portion of the molten material in the flow path 410 is sucked into the branch path 421, and a negative pressure is generated in the flow path 410. When the fiber material FB is not present in the flow path 410 and only the molten material is present, the control section 50 moves the plunger 422 to suck the molten material in the flow path 410. The ejection section 24 may not include the suction section 420.

As shown in FIG. 1, the stage 30 is arranged at a position facing the nozzle opening 431 of the nozzle 430. The shaping surface 31 of the stage 30 facing the nozzle opening 431 is arranged so as to be parallel to the X and Y directions, that is, the horizontal direction. The stage 30 may be provided with a stage heater for suppressing rapid cooling of the molten material ejected onto the stage 30.

The movement mechanism 40 changes the relative position between the stage 30 and the nozzle 430 under the control of the control section 50. In the present embodiment, the position of the nozzle 430 is fixed, and the movement mechanism 40 moves the stage 30. The movement mechanism 40 is configured by a three axis positioner that moves the stage 30 in three axial directions of the X, Y, and Z directions by driving forces of three servo motors. In the present specification, unless otherwise specified, movement of the nozzle 430 means that the nozzle 430 or the ejection section 24 is relatively moved with respect to the stage 30.

Note that in another embodiment, instead of the configuration in which the stage 30 is moved by the movement mechanism 40, a configuration may be adopted in which the position of the stage 30 is fixed and the movement mechanism 40 moves the nozzle 430 with respect to the stage 30. A configuration in which the movement mechanism 40 moves the stage 30 in the Z direction and the nozzle 430 in the X and Y directions, or a configuration in which the movement mechanism 40 moves the stage 30 in the X and Y directions and the nozzle 430 in the Z direction, may be adopted. Even using these configurations, the relative positional relationship between the nozzle 430 and the stage 30 can be changed.

The control section 50 is a control device that controls operation of the entire three-dimensional molding device 10. The control section 50 is configured by a computer including a CPU 51, a storage device 52, and an input/output interface that inputs and outputs signals to and from the outside. The control section 50 functions to execute a molding process for molding a three-dimensional molded object by the CPU 51 executing a program or a command read on the main storage device. In the molding process, the control section 50 controls the plasticizing section 110, the fiber material supply section 210, the material switching section 23, the ejection section 24, and the movement mechanism 40 according to the molding data for molding the three-dimensional molded object, and molds the three-dimensional molded object including the molten material on the stage 30. In another embodiment, the control section 50 may be realized by a combination of a plurality of circuits for realizing at least a portion of each function, instead of being constituted by a computer.

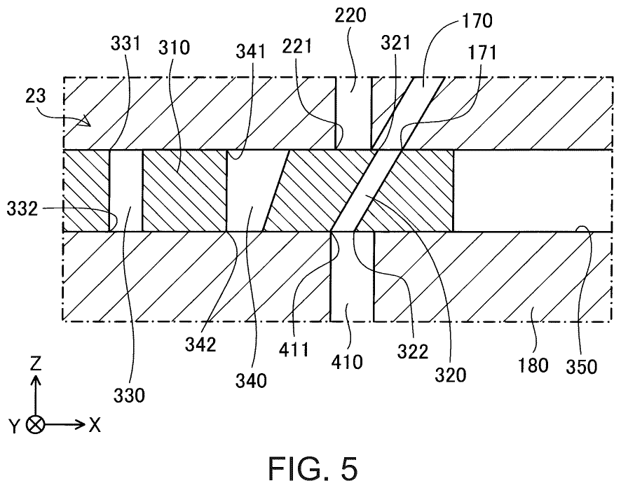

FIGS. 5 to 8 are cross-sectional views illustrating the structure of the material switching section 23 and the structure of its peripheral members.

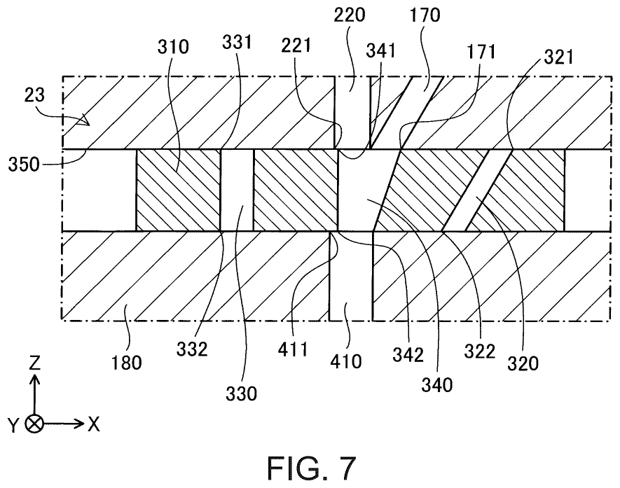

Hereinafter, the structure of the slide section 310 will be described with reference to FIG. 7. The slide section 310 is a plate-shaped member and includes a first path 320, a second path 330, and a third path 340, which are through holes penetrating the slide section 310 in the Z direction. The first path 320, the second path 330, and the third path 340 are arranged side by side along the first direction. In the present embodiment, the second path 330, the third path 340, and the first path 320 are arranged in this order from the −X direction toward the +X direction. The first path 320, the second path 330, and the third path 340 may be provided side by side along the first direction, and may not be provided in the order described above. The slide section 310 may be a rod-shaped member extending in the first direction.

The first path 320 is a through hole that allows the first communication path 170 and the flow path 410 to communicate with each other. The first path 320 has a first opening 321 connectable to the first communication path 170 and a second opening 322 connectable to the flow path 410. The first opening 321 is an opening located at an end section of the first path 320 on the +Z direction side, and the second opening 322 is an opening located at an end section of the first path 320 on the −Z direction side. The axial direction of the first path 320 is a direction along the axial direction of the first communication path 170 in the vicinity of the slide section 310. In the present embodiment, the axial direction of the first communication path 170 in the vicinity of the slide section 310 is an axial direction of a portion of the first communication path 170 extending obliquely with respect to the X direction in the XZ plane.

The second path 330 is a through hole that allows the second communication path 220 and the flow path 410 to communicate with each other. The second path 330 has a third opening 331 connectable to the second communication path 220 and a fourth opening 332 connectable to the flow path 410. The third opening 331 is the opening located at the end section of the second path 330 on the +Z direction side, and the fourth opening 332 is the opening located at the end section of the second path 330 on the −Z direction side. The axial direction of the second path 330 is a direction along the axial direction of the second communication path 220. In the present embodiment, the axial direction of the second path 330 is a direction along the Z direction.

The third path 340 is a through hole that allows the first communication path 170 and the flow path 410 to communicate with each other and allows the second communication path 220 and the flow path 410 to communicate with each other. The third path 340 has a fifth opening 341 connectable to the first communication path 170 and the second communication path 220, and a sixth opening 342 connectable to the flow path 410. The fifth opening 341 is the opening located at the end section of the third path 340 on the +Z direction side, and the sixth opening 342 is the opening located at the end section of the third path 340 on the −Z direction side. The opening area of the third path 340 in the cross section orthogonal to the axial direction of the flow path 410 decreases from the first communication path 170 and the second communication path 220 side toward the flow path 410 side. In the present embodiment, the axial direction of the flow path 410 is the Z direction, and the cross section orthogonal to the axial direction of the flow path 410 is the XY plane. The first communication path 170 and the second communication path 220 side is the +Z direction side, and the flow path 410 side is the −Z direction side. That is, the opening area of the third path 340 in the cross section orthogonal to the Z direction decreases from the +Z direction side toward the −Z direction side.

The control section 50 controls the material switching section 23 to switch among four modes: the first, second, third, and fourth modes Specifically, the control section 50 moves the slide section 310 in the first direction in the first hole 350 to switch among the first mode, the second mode, the third mode, and the fourth mode. Here, the first mode is a mode in which the first communication path 170 and the flow path 410 communicate with each other and the second communication path 220 and the flow path 410 do not communicate with each other. The second mode is a mode in which the first communication path 170 and the flow path 410 do not communicate with each other, and the second communication path 220 and the flow path 410 communicate with each other. The third mode is a mode in which the first communication path 170 and the second communication path 220 communicate with the flow path 410. The fourth mode is a mode in which neither the first communication path 170 nor the second communication path 220 communicates with the flow path 410.

FIGS. 5 to 8 show the position of the slide section 310 in the first hole 350 in each of the above-described modes. Hereinafter, the end section of the first communication path 170 connected to the material switching section 23 is referred to as a first communication path opening 171, the end section of the second communication path 220 connected to the material switching section 23 is referred to as a second communication path opening 221, and the end section of the flow path 410 connected to the material switching section 23 is referred to as a flow path opening 411.

FIG. 5 shows the position of the slide section 310 in the first hole 350 in the first mode. In the first mode, the control section 50 moves the slide section 310 to a position where at least a portion of the first communication path opening 171 overlaps with at least a portion of the first opening 321, at least a portion of the flow path opening 411 overlaps with at least a portion of the second opening 322, and the second communication path opening 221 does not overlap with any of the first opening 321, the third opening 331, or the fifth opening 341. Therefore, in the first mode, the molten material in the first communication path 170 passes through the first path 320 and flows out to the flow path 410, but the fiber material FB in the second communication path 220 is not transported to the flow path 410. Therefore, in the first mode, only the molten material is ejected from the nozzle 430. The ejection amount of the molten material from the nozzle 430 is controlled by adjusting the amount of the molten material generated by the plasticizing section 110, for example, by the control section 50 controlling the rotation speed of the flat screw 140.

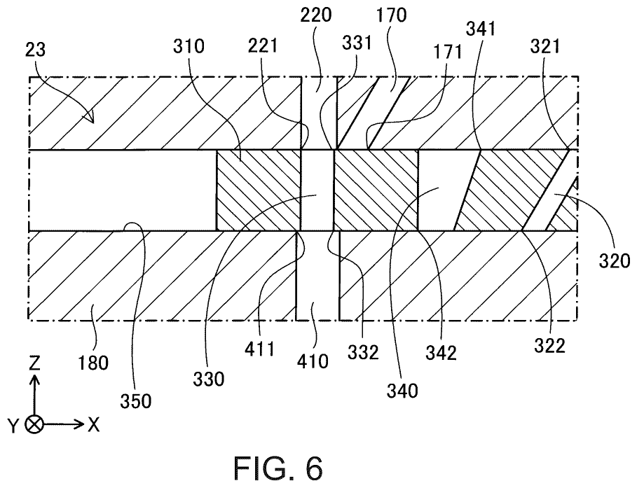

FIG. 6 shows the position of the slide section 310 in the first hole 350 in the second mode. In the second mode, the control section 50 moves the slide section 310 to a position where at least a portion of the second communication path opening 221 overlaps at least a portion of the third opening 331, at least a portion of the flow path opening 411 overlaps at least a portion of the fourth opening 332, and the first communication path opening 171 does not overlap any of the first opening 321, the third opening 331, or the fifth opening 341. Therefore, in the second mode, the molten material in the first communication path 170 does not flow out to the flow path 410, but the fiber material FB in the second communication path 220 is transported to the flow path 410 via the second path 330. Therefore, in the second mode, only the fiber material FB is ejected from the nozzle 430. The ejection amount of the fiber material FB from the nozzle 430 is controlled by the control section 50 controlling the rotation speed of the transport roller 212.

FIG. 7 shows the position of the slide section 310 in the first hole 350 in the third mode. In the third mode, the control section 50 moves the slide section 310 to a position where at least a portion of the first communication path opening 171 and at least a portion of the fifth opening 341 overlap each other, at least a portion of the second communication path opening 221 and at least a portion of the fifth opening 341 overlap each other, and at least a portion of the flow path opening 411 and at least a portion of the sixth opening 342 overlap each other. Therefore, in the third mode, the molten material in the first communication path 170 passes through the third path 340 and flows out to the flow path 410, and the fiber material FB in the second communication path 220 is transported to the flow path 410 via the third path 340. Therefore, in the third mode, the molten material and the fiber material FB are ejected from the nozzle 430

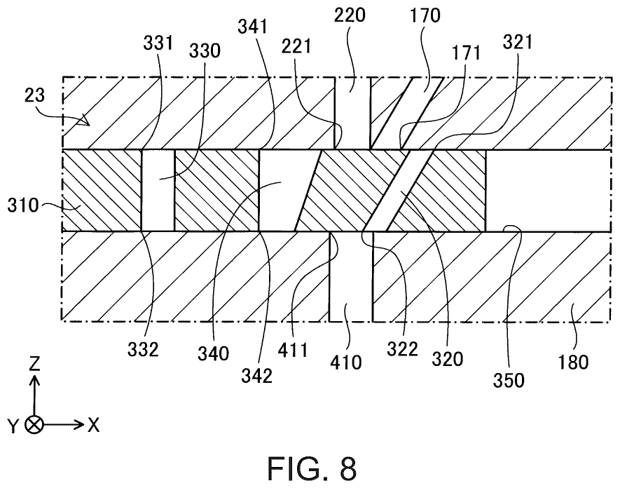

FIG. 8 shows the position of the slide section 310 in the first hole 350 in the fourth mode. In the fourth mode, the control section 50 moves the slide section 310 to a position where the first communication path opening 171 does not overlap any of the first opening 321, the third opening 331, and the fifth opening 341, and the second communication path opening 221 does not overlap any of the first opening 321, the third opening 331, or the fifth opening 341. Therefore, in the fourth mode, the molten material in the first communication path 170 does not flow out to the flow path 410, and the fiber material FB in the second communication path 220 is not transported to the flow path 410. Therefore, in the fourth mode, neither the molten material nor the fiber material FB is ejected from the nozzle 430.

The control section 50 switches between the modes according to the molding data for molding the three-dimensional molded object. The control section 50 switches between the modes so that the fiber material FB is ejected to a portion of the three-dimensional molded object where the strength is to be improved, for example. The section of the three-dimensional molded object where the strength is desired to be improved is, for example, the outer enclosure of the three-dimensional molded object.

When the fiber material FB is cut, the control section 50 moves the slide section 310 from a position where at least a portion of the second communication path opening 221 and at least a portion of the third opening 331 overlap each other to a position where the second communication path opening 221 and the third opening 331 do not overlap each other. Alternatively, when the fiber material FB is cut, the control section 50 moves the slide section 310 from a position where at least a portion of the second communication path opening 221 and at least a portion of the fifth opening 341 overlap each other to a position where the second communication path opening 221 and the fifth opening 341 do not overlap each other. Accordingly, the fiber material FB is bent in the vicinity of the second communication path opening 221, and thus the fiber material FB is cut. The case of cutting the fiber material FB is a case of changing from a state in which the fiber material FB is ejected from the nozzle 430 to a state in which the fiber material FB is not ejected from the nozzle 430. For example, a case where the mode is switched from the second mode to the first mode or a case where the mode is switched from the third mode to the fourth mode corresponds to a case where the fiber material FB is cut.

According to the first embodiment described above, the control section 50 controls the slide section 310 to switch among: a first mode in which the first communication path 170, which communicates with the plasticizing section 110, communicates with the flow path 410 that communicates with the nozzle 430, while the second communication path 220 that communicates with the fiber material supply section 210 does not communicate with the flow path 410; a second mode in which the first communication path 170 does not communicate with the flow path 410, while the second communication path 220 communicates with the flow path 410; a third mode in which both the first communication path 170 and the second communication path 220 communicate with the flow path 410; and a fourth mode in which neither the first communication path 170 nor the second communication path 220 communicates with the flow path 410. Therefore, it is possible to switch between the ejection of the molten material from the nozzle 430 and the ejection of the fiber material FB.

In the present embodiment, the slide section 310 includes the first path 320 which is a through hole capable of communicating the first communication path 170 and the flow path 410, the second path 330 which is a through hole capable of communicating the second communication path 220 and the flow path 410, and the third path 340 which is a through hole capable of communicating the first communication path 170 and the flow path 410 and communicating the second communication path 220 and the flow path 410 The axial direction of first path 320 is a direction along the axial direction of first communication path 170 in the vicinity of slide section 310, the axial direction of second path 330 is a direction along the axial direction of second communication path 220, and the opening area of third path 340 in the cross section orthogonal to the axial direction of flow path 410 decreases from the side of first communication path 170 and second communication path 220 toward the side of flow path 410. Therefore, by moving the slide section 310, it is possible to easily switch between the ejection of the molten material and the ejection of the fiber material FB, from the nozzle 430.

In present embodiment, in the first mode, the control section 50 moves the slide section 310 to the position such that at least a portion of the first communication path opening 171, which is the end section of the first communication path 170 connected to the material switching section 23, overlaps with at least a portion of the first opening 321; at least a portion of the flow path opening 411, which is the end section of the flow path 410 connected to the material switching section 23, overlaps with at least a portion of the second opening 322; and the second communication path opening 221, which is the end section of the second communication path 220 connected to the material switching section 23, is positioned so that it does not overlap with any of the first opening 321, the third opening 331, or the fifth opening 341. Therefore, in the first mode, only the molten material can be ejected from the nozzle 430.

In the present embodiment, in the second mode, the control section 50 moves the slide section 310 to the position such that at least the portion of the second communication path opening 221, which is the end section of the second communication path 220 connected to the material switching section 23, overlaps with at least the portion of the third opening 331; at least the portion of the flow path opening 411, which is the end section of the flow path 410 connected to the material switching section 23, overlaps with at least the portion of the fourth opening 332; and the first communication path opening 171, which is the end section of the first communication path 170 connected to the material switching section 23, is positioned so as not to overlap with any of the first opening 321, the third opening 331, or the fifth opening 341. Therefore, in the second mode, only the fiber material FB can be ejected from the nozzle 430.

In the present embodiment, in the third mode, the control section 50 moves the slide section 310 to a position such that at least a portion of a first communication path opening 171, which is an end section of a first communication path 170 connected to the material switching section 23, overlaps with at least a portion of a fifth opening 341; at least a portion of a second communication path opening 221, which is an end section of a second communication path 220 connected to the material switching section 23, overlaps with at least a portion of the fifth opening 341; and at least a portion of a flow path opening 411, which is an end section of a flow path 410 connected to the material switching section 23, overlaps with at least a portion of a sixth opening 342. Therefore, in the third mode, both the molten material and the fiber material FB can be ejected from the nozzle 430.

In the present embodiment, in the fourth mode, the control section 50 moves the slide section 310 to a position such that a first communication path opening 171, which is the end section of a first communication path 170 connected to the material switching section 23, does not overlap with any of the first opening 321, the third opening 331, or the fifth opening 341; and a second communication path opening 221, which is the end section of a second communication path 220 connected to the material switching section 23, is positioned so as not to overlap with any of the first opening 321, the third opening 331, or the fifth opening 341. Therefore, in the fourth mode, it is possible to prevent neither the molten material nor the fiber material FB from being ejected from the nozzle 430.

In the present embodiment, the heat insulation material 250 is provided between the second communication path 220 and the plasticizing section 110. Therefore, it is possible to reduce the influence of the heat of the plasticizing section 110 on the fiber material FB passing through the second communication path 220.

In addition, in the present embodiment, the nozzle heater 440 is arranged around a portion of the flow path 410 located in the vicinity of the nozzle 430. Therefore, since the molten material can be heated immediately before being ejected from the nozzle 430, the molten material can be more stably ejected from the nozzle 430.

In the present embodiment, the ejection section 24 has a suction section 420 including a branch path 421, connected to the flow path 410, and a plunger 422, which moves within the branch path 421. The control section 50 controls the suction section 420 and causes the plunger 422 to move, thereby sucking the molten material within the flow path 410 into the branch path 421. Therefore, when the ejection of the molten material from the nozzle 430 is stopped, the molten material can be prevented from drooping from the nozzle 430 so as to pull a thread.

### B. Other Embodiments

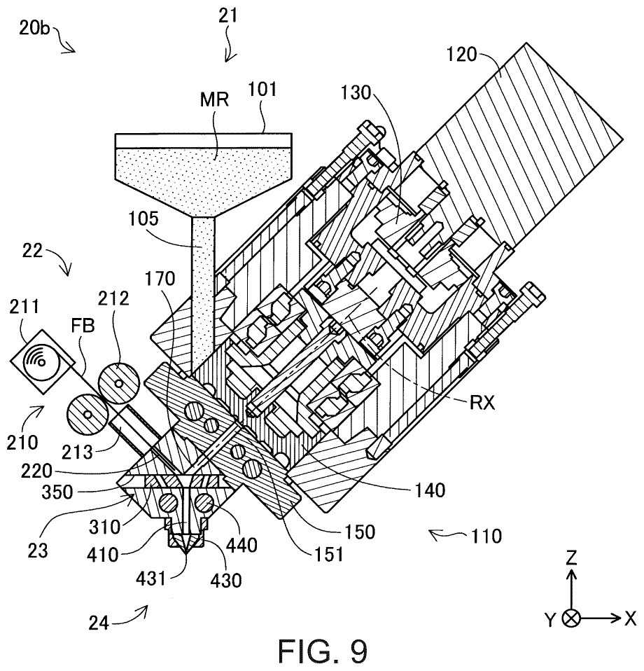

(B-1) In the above-described embodiment, the axial direction of the second communication path 220 is a direction along the axial direction of the flow path 410. In contrast, the axial direction of the second communication path 220 may not be along the axial direction of the flow path 410. FIG. 9 is the explanatory diagram illustrating the example of a schematic configuration of the molding section 20b in another embodiment. In the example illustrated in FIG. 9, the axial direction of the flow path 410 is a direction along the Z direction, and the axial direction of the second communication path 220 is a direction inclined by 45° from the Z axis in the XZ plane. The axial direction of the second communication path 220 is not limited to 45°, and may be inclined at any angle in a range of more than 0° and 90° or less from the Z axis in the XZ plane.

(B-2) In the above-described embodiment, the axial direction of the first path 320 is a direction along the axial direction of the first communication path 170 in the vicinity of the slide section 310. In contrast, the axial direction of the first path 320 may not be a direction along the axial direction of the first communication path 170 in the vicinity of the slide section 310.

(B-3) In the above-described embodiment, the axial direction of the second path 330 is a direction along the axial direction of the second communication path 220. In contrast, the axial direction of the second path 330 may not be a direction along the axial direction of the second communication path 220.

(B-4) In the above-described embodiment, the opening area of the third path 340 in the cross section orthogonal to the axial direction of the flow path 410 decreases from the first communication path 170 and the second communication path 220 side toward the flow path 410 side. In contrast, the opening area of the third path 340 in the cross section orthogonal to the axial direction of the flow path 410 may not decrease from the first communication path 170 and the second communication path 220 side toward the flow path 410 side.

(B-5) In the above-described embodiment, in the first mode, the control section 50 moves the slide section 310 to a position where at least a portion of the first communication path opening 171 overlaps at least a portion of the first opening 321, at least a portion of the flow path opening 411 overlaps at least a portion of the second opening 322, and the second communication path opening 221 does not overlap any of the first opening 321, the third opening 331, or the fifth opening 341. In contrast, in the first mode, the control section 50 may not move the slide section 310 to a position where at least a portion of the first communication path opening 171 and at least a portion of the first opening 321 overlap each other, at least a portion of the flow path opening 411 and at least a portion of the second opening 322 overlap each other, and the second communication path opening 221 does not overlap any of the first opening 321, the third opening 331, or the fifth opening 341.

(B-6) In the above-described embodiment, in the second mode, the control section 50 moves the slide section 310 to a position where at least a portion of the second communication path opening 221 and at least a portion of the third opening 331 overlap each other, at least a portion of the flow path opening 411 and at least a portion of the fourth opening 332 overlap each other, and the first communication path opening 171 does not overlap any of the first opening 321, the third opening 331, or the fifth opening 341. In contrast, in the second mode, the control section 50 may not move the slide section 310 to a position where at least a portion of the second communication path opening 221 and at least a portion of the third opening 331 overlap each other, at least a portion of the flow path opening 411 and at least a portion of the fourth opening 332 overlap each other, and the first communication path opening 171 does not overlap any of the first opening 321, the third opening 331, or the fifth opening 341.

(B-7) In the above-described embodiment, in the third mode, the control section 50 moves the slide section 310 to a position where at least a portion of the first communication path opening 171 and at least a portion of the fifth opening 341 overlap each other, at least a portion of the second communication path opening 221 and at least a portion of the fifth opening 341 overlap each other, and at least a portion of the flow path opening 411 and at least a portion of the sixth opening 342 overlap each other. In contrast, in the third mode, the control section 50 may not move the slide section 310 to a position where at least a portion of the first communication path opening 171 and at least a portion of the fifth opening 341 overlap each other, at least a portion of the second communication path opening 221 and at least a portion of the fifth opening 341 overlap each other, and at least a portion of the flow path opening 411 and at least a portion of the sixth opening 342 overlap each other.

(B-8) In the above-described embodiment, in the fourth mode, the control section 50 moves the slide section 310 to a position where the first communication path opening 171 does not overlap any of the first opening 321, the third opening 331, and the fifth opening 341, and the second communication path opening 221 does not overlap any of the first opening 321, the third opening 331, or the fifth opening 341. In contrast, in the fourth mode, the control section 50 may not move the slide section 310 to a position where the first communication path opening 171 does not overlap any of the first opening 321, the third opening 331, and the fifth opening 341, and the second communication path opening 221 does not overlap any of the first opening 321, the third opening 331, or the fifth opening 341.

(B-9) In the above-described embodiment, when the fiber material FB is cut, the control section 50 moves the slide section 310 from the position where at least a portion of the second communication path opening 221 and at least a portion of the third opening 331 overlap each other to the position where the second communication path opening 221 and the third opening 331 do not overlap each other. Alternatively, when the fiber material FB is cut, the control section 50 moves the slide section 310 from a position where at least a portion of the second communication path opening 221 and at least a portion of the fifth opening 341 overlap each other to a position where the second communication path opening 221 and the fifth opening 341 do not overlap each other. In contrast, the molding section 20 may include a cutting section, and the control section 50 may control the cutting section to cut the fiber material FB. The cutting section is configured by, for example, a cutter blade or a laser emitting mechanism.

(B-10) In the above-described embodiment, the heat insulation material 250 is provided between the second communication path 220 and the plasticizing section 110. In contrast, the heat insulation material 250 may not be provided between the second communication path 220 and the plasticizing section 110.

(B-11) In the above-described embodiment, the ejection section 24 includes the nozzle heater 440. In contrast, the ejection section 24 may not include the nozzle heater 440.

(B-12) In the above-described embodiment, the ejection amount of the molten material from the nozzle 430 is controlled, for example, by the control section 50 controlling the rotation speed of the flat screw 140. On the other hand, the ejection amount of the molten material from the nozzle 430 may be controlled by changing the area of the portion where the first communication path opening 171 and the first opening 321 overlap each other by the control section 50 controlling the position of the slide section 310 in the first hole 350.

(B-13) In the above-described embodiment, the second communication path 220 is a hole extending linearly. In contrast, the second communication path 220 may be a bent hole.

(B-14) In the above-described embodiment, the first direction is the X direction. In contrast, the first direction may be a direction intersecting the axial direction of the flow path 410, and may not be the X direction.

(B-15) In the above-described embodiment, in the fourth mode, the control section 50 moves the slide section 310 to a position where the first communication path opening 171 does not overlap any of the first opening 321, the third opening 331, and the fifth opening 341, and the second communication path opening 221 does not overlap any of the first opening 321, the third opening 331, or the fifth opening 341. In contrast, in the fourth mode, the control section 50 may move the slide section 310 to a position where the flow path opening 411 does not overlap any of the second opening 322, the fourth opening 332, or the sixth opening 342.

### C. Other Forms

The present disclosure is not limited to the above-described embodiment, but can be realized in various forms without departing from the scope of the present disclosure. For example, the present disclosure can also be realized by the following forms. The technical features in the above-described embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

1. According to a first aspect of the present disclosure, the three-dimensional molding device is provided. The three-dimensional molding device includes a plasticizing section that plasticizes at least a portion of material containing thermoplastic resin to generate molten material; a fiber material supply section that supplies fiber material; a first communication path that communicates with the plasticizing section and through which the molten material passes; a second communication path that communicates with the fiber material supply section and through which the fiber material passes; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage, wherein the material switching section includes a slide section that moves in a direction intersecting an axial direction of the flow path and the control section controls the material switching section to switch among a first mode in which the first communication path is in communication with the flow path and the second communication path is not in communication with the flow path, a second mode in which the second communication path is in communication with the flow path and the first communication path is not in communication with the flow path, a third mode in which both the first communication path and the second communication path are in communication with the flow path, and a fourth mode in which neither the first communication path nor the second communication path is in communication with the flow path.

According to this configuration, it is possible to switch between the ejection of the molten material and the ejection of the fiber material from the nozzle.

(2) The above-described aspect may be such that the slide section includes a first path that is a through hole that allows communication between the first communication path and the flow path, a second path that is a through hole that allows communication between the second communication path and the flow path, and a third path that is a through hole that allows communication between the first communication path and the flow path, and between the second communication path and the flow path, an axial direction of the first path is aligned with an axial direction of the first communication path in the vicinity of the slide section, an axial direction of the second path is aligned with an axial direction of the second communication path, an opening area of the third path in a cross section orthogonal to the axial direction of the flow path decreases in size from the first communication path toward the flow path and the second communication path toward the flow path, the first path includes a first opening connectable to the first communication path and a second opening connectable to the flow path, the second path includes a third opening connectable to the second communication path and a fourth opening connectable to the flow path, and the third path includes a fifth opening connectable to both the first communication path and the second communication path and a sixth opening connectable to the flow path.

According to this configuration, by moving the slide section, it is possible to easily switch between the ejection of the molten material and the ejection of the fiber material from the nozzle.

(3) The above-described aspect may be such that the control section, in the first mode, causes the slide section to move to a position where at least a portion of a first communication path opening, which is an end section of the first communication path connected to the material switching section, overlaps with at least a portion of the first opening section, where at least a portion of a flow path opening, which is an end section of the flow path connected to the material switching section, overlaps with at least a portion of the second opening, and where a second communication path opening, which is an end section of the second communication path connected to the material switching section, does not overlap with any of the first opening, the third opening, or the fifth opening.

According to this configuration, only the molten material can be ejected from the nozzle in the first mode.

(4) The above-described aspect may be such that the control section, in the second mode causes the slide section to move to a position where at least a portion of a second communication path opening, which is an end section of the second communication path connected to the material switching section, overlaps with at least a portion of the third opening, where at least a portion of a flow path opening, which is an end section of the flow path connected to the material switching section, overlaps with at least a portion of the fourth opening, and where a first communication path opening, which is an end section of the first communication path connected to the material switching section, is positioned so as not to overlap with any of the first opening, the third opening, or the fifth opening.

According to this configuration, only the fiber material can be ejected from the nozzle in the second mode.

(5) The above-described aspect may be such that the control section, in the third mode, causes the slide section to move to a position where at least a portion of a first communication path opening, which is an end section of the first communication path connected to the material switching section, overlaps with at least a portion of the fifth opening, where at least a portion of a second communication path opening, which is an end section of the second communication path connected to the material switching section, overlaps with at least a portion of the fifth opening and where at least a portion of a flow path opening, which is an end section of the flow path connected to the material switching section, overlaps with at least a portion of the sixth opening.

According to this configuration, both the molten material and the fiber material can be ejected from the nozzle in the third mode.

(6) The above-described aspect may be such that the control section, in the fourth mode, causes the slide section to move to a position where a first communication path opening, which is an end section of the first communication path connected to the material switching section, does not overlap with any of the first opening, the third opening, or the fifth opening, and where a second communication path opening, which is an end section of the second communication path connected to the material switching section, does not overlap with any of the first opening, the third opening, or the fifth opening.

According to this configuration, neither the molten material nor the fiber material can be ejected from the nozzle in the fourth mode.

(7) The above-described aspect may further include a heat insulation material arranged between the second communication path and the plasticizing section.

According to this configuration, it is possible to reduce the influence of the heat of the plasticizing section on the fiber material passing through the second communication path.

(8) The above-described aspect may further include a nozzle heater that is arranged around a portion of the flow path located near the nozzle.

According to this configuration, since the molten material can be heated immediately before being ejected from the nozzle, the molten material can be more stably ejected from the nozzle.

(9) The above-described aspect may further include a suction section that sucks the molten material in the flow path, wherein the suction section includes a branch path that is connected to the flow path and a plunger that moves within the branch path and the control section controls the suction section to move the plunger to suck the molten material in the flow path into the branch path.

According to this configuration, when the ejection of the molten material from the nozzle is stopped, it is possible to suppress the molten material from drooping from the nozzle so as to pull a thread.

What is claimed is:

1. A three-dimensional molding device comprising:
a plasticizing section that plasticizes at least a portion of material containing thermoplastic resin to generate molten material;
a fiber material supply section that supplies fiber material;
a first communication path that communicates with the plasticizing section and through which the molten material passes;
a second communication path that communicates with the fiber material supply section and through which the fiber material passes;
a flow path configured to allow passage of the molten material that passed through the first communication path and the fiber material that passed through the second communication path;
a material switching section connected to the first communication path, to the second communication path, and to the flow path, and configured to switch communication state of the first communication path, the second communication path, and the flow path;
a nozzle that communicates with the flow path and that ejects the molten material and the fiber material that passed through the flow path onto a stage; and
a control section configured to control the plasticizing section, the fiber material supply section, and the material switching section to form a three-dimensional molded object including the molten material on the stage, wherein
the material switching section includes a slide section that moves in a direction intersecting an axial direction of the flow path and
the control section controls the material switching section to switch among
a first mode in which the first communication path is in communication with the flow path and the second communication path is not in communication with the flow path,
a second mode in which the second communication path is in communication with the flow path and the first communication path is not in communication with the flow path,
a third mode in which both the first communication path and the second communication path are in communication with the flow path, and
a fourth mode in which neither the first communication path nor the second communication path is in communication with the flow path.

2. The three-dimensional molding device according to claim 1, wherein
the slide section includes
a first path that is a through hole that allows communication between the first communication path and the flow path,
a second path that is a through hole that allows communication between the second communication path and the flow path, and
a third path that is a through hole that allows communication between the first communication path and the flow path, and between the second communication path and the flow path,
an axial direction of the first path is aligned with an axial direction of the first communication path in the vicinity of the slide section,
an axial direction of the second path is aligned with an axial direction of the second communication path,
an opening area of the third path in a cross section orthogonal to the axial direction of the flow path decreases in size from the first communication path toward the flow path and the second communication path toward the flow path,
the first path includes a first opening connectable to the first communication path and a second opening connectable to the flow path,
the second path includes a third opening connectable to the second communication path and a fourth opening connectable to the flow path, and
the third path includes a fifth opening connectable to both the first communication path and the second communication path and a sixth opening connectable to the flow path.

3. The three-dimensional molding device according to claim 2, wherein
the control section, in the first mode, causes the slide section to move to a position
where at least a portion of a first communication path opening, which is an end section of the first communication path connected to the material switching section, overlaps with at least a portion of the first opening section,
where at least a portion of a flow path opening, which is an end section of the flow path connected to the material switching section, overlaps with at least a portion of the second opening, and
where a second communication path opening, which is an end section of the second communication path connected to the material switching section, does not overlap with any of the first opening, the third opening, or the fifth opening.

4. The three-dimensional molding device according to claim 2, wherein
the control section, in the second mode, causes the slide section to move to a position
where at least a portion of a second communication path opening, which is an end section of the second communication path connected to the material switching section, overlaps with at least a portion of the third opening,
where at least a portion of a flow path opening, which is an end section of the flow path connected to the material switching section, overlaps with at least a portion of the fourth opening, and
where a first communication path opening, which is an end section of the first communication path connected to the material switching section, is positioned so as not to overlap with any of the first opening, the third opening, or the fifth opening.

5. The three-dimensional molding device according to claim 2, wherein
the control section, in the third mode, causes the slide section to move to a position
where at least a portion of a first communication path opening, which is an end section of the first communication path connected to the material switching section, overlaps with at least a portion of the fifth opening,
where at least a portion of a second communication path opening, which is an end section of the second communication path connected to the material switching section, overlaps with at least a portion of the fifth opening and
where at least a portion of a flow path opening, which is an end section of the flow path connected to the material switching section, overlaps with at least a portion of the sixth opening.

6. The three-dimensional molding device according to claim 2, wherein
the control section, in the fourth mode, causes the slide section to move to a position
where a first communication path opening, which is an end section of the first communication path connected to the material switching section, does not overlap with any of the first opening, the third opening, or the fifth opening, and
where a second communication path opening, which is an end section of the second communication path connected to the material switching section, does not overlap with any of the first opening, the third opening, or the fifth opening.

7. The three-dimensional molding device according to claim 1, further comprising:
a heat insulation material arranged between the second communication path and the plasticizing section.

8. The three-dimensional molding device according to claim 1, further comprising:
a nozzle heater that is arranged around a portion of the flow path located near the nozzle.

9. The three-dimensional molding device according to claim 1, further comprising:
a suction section that sucks the molten material in the flow path, wherein
the suction section includes
a branch path that is connected to the flow path and
a plunger that moves within the branch path and
the control section controls the suction section to move the plunger to suck the molten material in the flow path into the branch path.
